(19) United States
(12) Patent Application Publication
(10) Pub. No.: US 2016/0230457 A1
(43) Pub. Date: Aug. 11, 2016

(54) APPARATUS AND METHOD FOR PREVENTING VERTICAL BLIND VANE SWAYING

(71) Applicant: John I. Trujillo, El Cajon, CA (US)

(72) Inventor: John I. Trujillo, El Cajon, CA (US)

(21) Appl. No.: 14/706,899

(22) Filed: May 7, 2015

Related U.S. Application Data
(63) Continuation-in-part of application No. 14/615,658, filed on Feb. 6, 2015.

(51) Int. Cl. E06B 9/388; E06B 9/36

(52) U.S. Cl. CPC E06B 9/388; E06B 9/36; E06B 9/365; E06B 9/364

(57) ABSTRACT

An apparatus and method for preventing swaying of vertical blind vanes is provided wherein a tensioned cord is positioned between the vertical vanes and the window sill, said cord being coupled to anchoring means that are anchored to the insides of the window frame. The cord runs through a plurality of clips coupled with eyelet holes, said clips being attached to the bottom edges of the vanes at the vanes' mid-point, allowing the vanes to rotate. A plurality of vertical blind vanes having curled lateral edges is also provided wherein said curled lateral edges cause the vanes to interlock when they are in a closed position. A track contains sliding retainers for holding the lower edge of the vanes using clips. The retainers may move within the track on wheels or other friction-reducers. The retainers are inserted into the track from the track end and are closed by terminating blocks.

### CROSS-REFERENCE TO RELATED APPLICATION

The present application is a continuation-in-part of, and claims priority to, U.S. Nonprovisional patent application Ser. No. 14/615,658 filed on Feb. 6, 2015, entitled “Apparatus and Method for Preventing Vertical Blind Vane Swaying”, the entire disclosure of which is incorporated by reference herein.

### FIELD OF THE INVENTION

The present invention is directed generally to vertical blinds used to shade the interior of buildings, and more particularly, to an apparatus and method for preventing vertical blind vanes from swaying.

### BACKGROUND OF THE INVENTION

Most vertical blinds hang freely from a head rail using clips at the top of each vane located at the center of the vertical rotation of the vanes. The horizontal spacing and rotation of the clips about a vertical axis of rotation is controlled by a mechanism in the head rail that in turn is controlled by cords or rods operated by a user.

The vanes are generally free to swing about their points of attachment to the head rail in axes perpendicular to the vertical axis of rotation. The vanes are often made of a flexible material, which allows them to bend and twist. The vanes can easily sway or rattle individually in the wind, a house fan, or in response to users touching them, causing noise when the vanes collide with each other. Swaying or flapping can cause vanes to become stuck in the window track, leaving a gap between the vanes which compromises privacy. Excessive swaying or flapping can cause vanes to break at the top where they are attached to the head rail.

The prior art teaches several means for stabilizing vertical vanes to reduce rattling or swaying movement, including chains attached to the lower part of the vanes and complicated foot rail apparatuses. The chains tend to be highly visible and unsightly and still allow vertical vanes to sway to such an extent that they provide limited or no noise reduction. The foot rail apparatuses tend to be highly visible, complex and difficult to install. An object of the present invention is to overcome the above disadvantages in the prior art by providing an apparatus and method for preventing vertical blind vane rattling and swaying which is highly effective, minimally visible and easy to install.

### SUMMARY OF THE INVENTION

A first aspect of the present invention provides a cord positioned between the vertical vanes and the window sill. Said cord runs the width of the vertical blinds and, in one embodiment of the present invention, is stabilized by being coupled to anchoring means that are anchored to the insides of the window frame. A plurality of clips coupled with eyelet holes is also provided. The cord runs through the eyelet holes. The clips are attached to the bottom edges of the vanes at the vanes' mid-point, allowing the vanes to rotate. The cord is tensioned such that any pendulum motion of the vertical vanes is prevented. The eyelet holes provide a stable means of coupling the cord to the clips while allowing movement of the vanes along the plane of the cord.

Brackets can be used to stabilize the cord for vertical blinds on windows that are not inside of a window frame and instead are hung from the wall with the head rail anchored to the wall above the window. In this embodiment of the present invention, the brackets are attached to the wall on either side of the vertical blinds and are of sufficient size to position the cord below the vertical vanes.

A second aspect of the present invention provides a plurality of vertical blind vanes having curled lateral edges. On each vane, one lateral edge curls toward one surface of the vane while the other lateral edge curls toward the opposite surface of the vane, such that the lateral edges of adjacent vanes interlock when the vanes are in a closed position, inhibiting the pendulum movement of the vanes. The second aspect of the present invention may be employed in conjunction with the first aspect of the present invention or may be practiced separately as a means to reduce pendulum movement in vertical vane blinds on its own. A further embodiment of the present invention has a track having a t-shaped groove therein, and one or more retainers slidably disposed within the track, the retainer comprising a clip for removably retaining blinds and a friction-reducer configured to facilitate movement of the retainers within the track.

### BRIEF DESCRIPTION OF THE DRAWINGS

The invention may be understood by reference to the following description taken in conjunction with the accompanying drawings, in which, like reference numerals identify like elements, and in which:

FIG. 1 illustrates a front plan view of the first aspect of the present invention;

FIG. 2 illustrates a front perspective view of the first aspect of the present invention;

FIG. 3 illustrates an enlarged perspective view of the clip/eyelet hole component of the first aspect of the present invention;

FIG. 4 illustrates a perspective view of the second aspect of the present invention;

FIG. 5 illustrates an enlarged perspective view of the second aspect of the present invention;

FIG. 6 illustrates a view of the vanes retainers within the track, according to an embodiment of the present invention; and

FIG. 7 illustrates a detail view of the retainer, according to an embodiment of the present invention.

### DETAILED DESCRIPTION

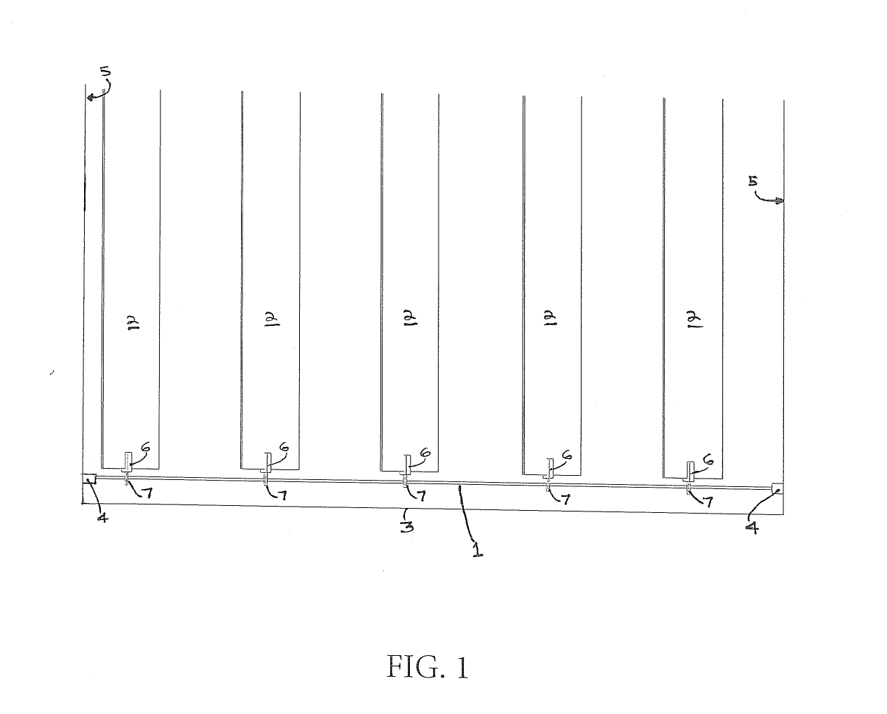

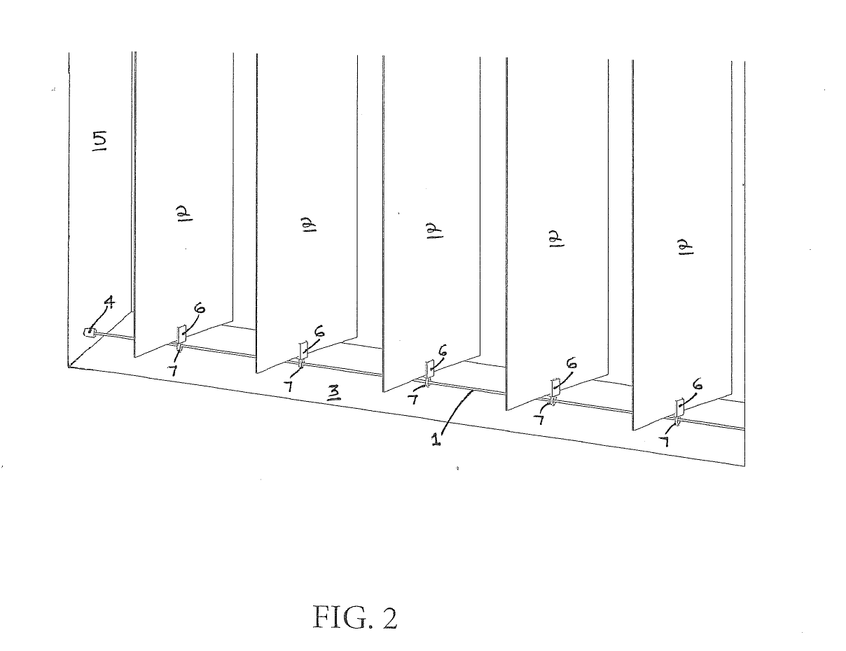

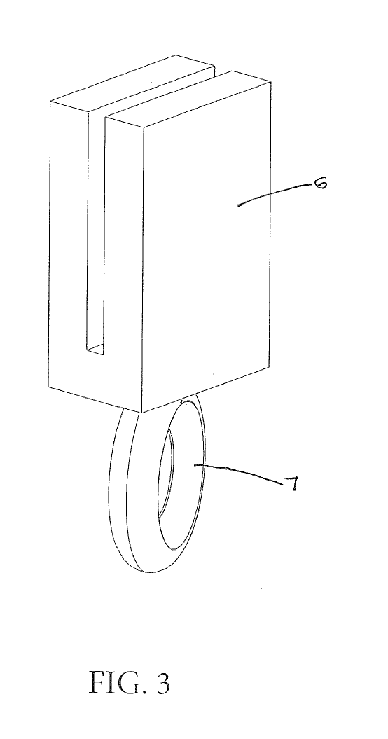

FIGS. 1-3 illustrate the first aspect of the present invention wherein a cord 1 is positioned between vertical vanes 2 and window sill 3. Cord 1 runs the width of the vertical blinds and, in one embodiment of the present invention, is stabilized by being coupled to anchors 4 that are anchored to the insides of the window frame 5. A plurality of clips 6 coupled with eyelet holes 7 are also provided. Cord 1 runs through eyelet holes 7. Clips 6 are attached to the bottom edges of vanes 2 at the vanes' mid-point, allowing vanes 2 to rotate. Cord 1 is tensioned such that any pendulum motion of the vertical vanes is prevented. Eyelet holes 7 provide a stable means for coupling cord 1 to clips 6 while allowing movement of vanes 2 along the plane of cord 1.

Brackets can be used to stabilize cord 1 for vertical blinds on windows that are not inside of a window frame and instead are hung from the wall with the head rail anchored to the wall above the window. In this embodiment of the present invention, the brackets are attached to the wall on either side of the vertical blinds and are of sufficient size to position cord 1 below vanes 2.

The first aspect of the present invention may be easily installed on most standard vertical blind sets by positioning cord 1 below vanes 2 and securing cord 1 in a tensioned manner by means of anchoring means 4 to the sides of the window frame 5 or brackets on the sides of the window for vertical blind sets installed on windows without frames.

Cord 1 may be made of a variety of materials suitable to provide the necessary strength and tension while being minimally visible (i.e. having a small diameter and preferably transparent). For example, cord 1 may be a fishing line, or a similarly small-diameter cord made of nylon, polyethylene, metal, etc.

Clips 6 are preferably transparent and made of a hard, slightly elastic plastic material such that clips 6 are easily installed by sliding them onto the bottoms of vanes 2, yet tightly and securely grip vanes 2 once installed. Clips 6 may be made of materials other than plastic which are capable of sliding onto and gripping vanes 2, such as metal.

Anchors 4 comprise any means known in the art for securing a cord, such as crimped metal, coupled with a wall screw or any other means known in the art for coupling anchoring means 4 to the sides of window frame 5.

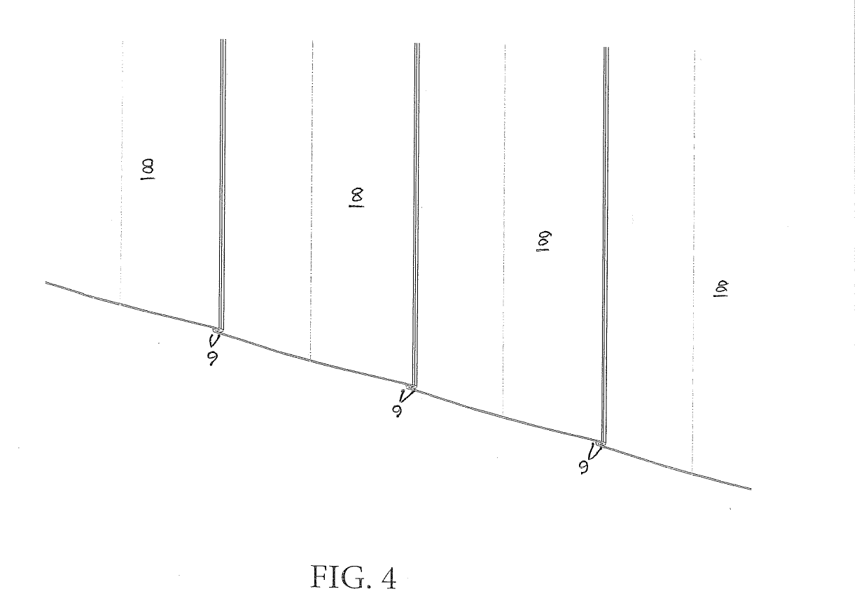

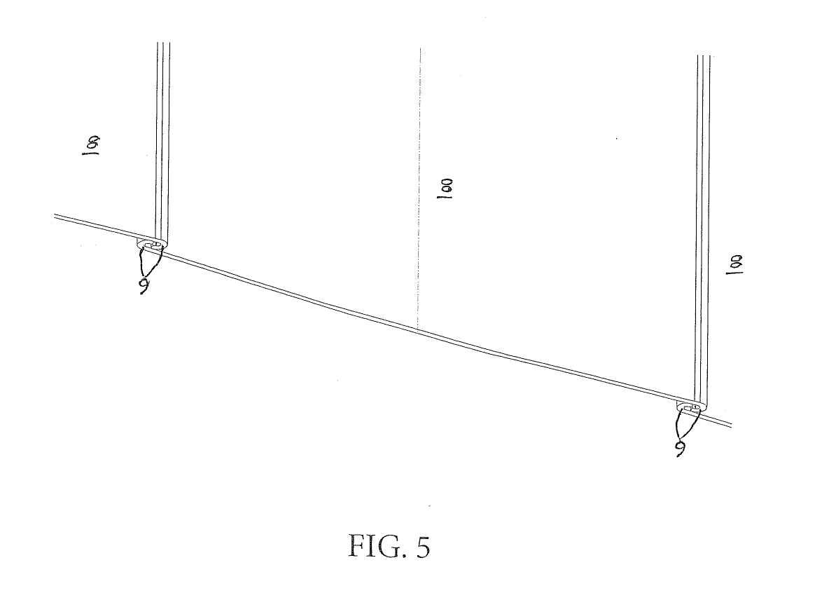

FIGS. 4 and 5 illustrate the second aspect of the present invention provides a plurality of vertical blind vanes 8 having curled lateral edges 9. On each vane 8, one lateral edge 9 curls toward one surface of vane 8 while the other lateral edge 9 curls toward the opposite surface of vane 8, such that lateral edges 9 of adjacent vanes 8 interlock when vanes 8 are in a closed position, inhibiting the pendulum movement of vanes 8. The second aspect of the present invention may be employed in conjunction with the first aspect of the present invention or may be practiced separately as a means to reduce pendulum movement in vertical vane blinds on its own.

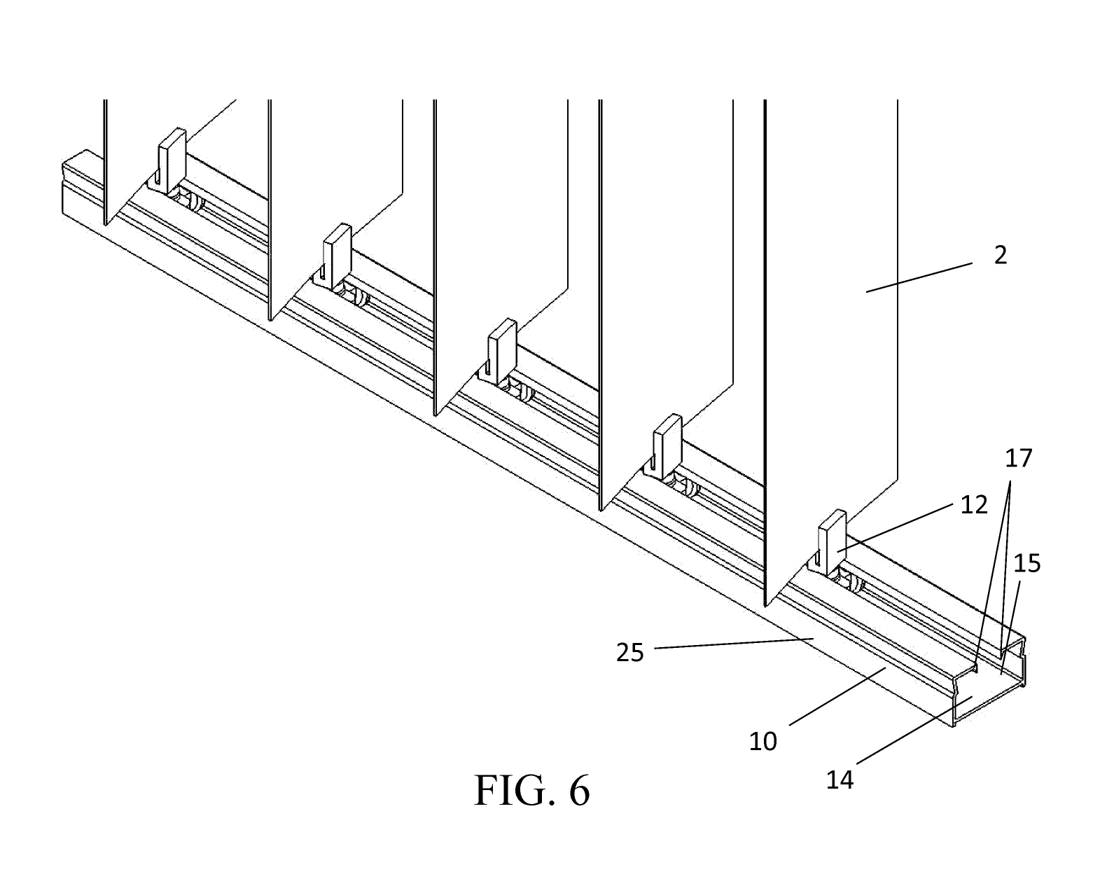

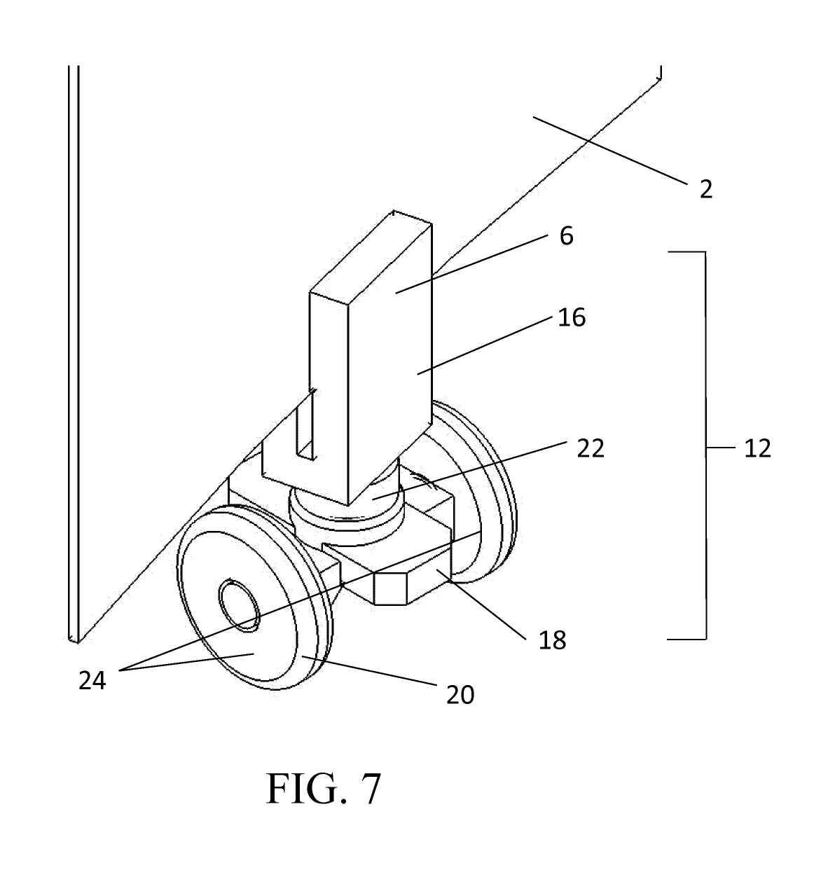

FIGS. 6 and 7 illustrate an embodiment of the invention wherein the vertical blind vanes 2 are retained by a sliding retainer 12 within a track 10. The track 10 is positioned below the vanes 2, either within the window frame or outside. If mounted outside of the window frame, the track 10 may be mounted on brackets (not shown) affixed to the wall that project from the wall to position the track 10 beneath the vanes 2. The track 10 has a T-shaped groove 14 therein for holding a retainer 12 and facilitating movement of the retainer 12 along the track 10, and the track 10 is terminated on each end by a terminating block (not shown) that fits within the open end 15 of the track 10. In an embodiment, the groove 14 has a lip 17 therein on each side of the opening, to hold the wheels within their respective side of the groove 14. The terminating block (not shown) is removable to allow one or more retainers to be inserted therein, and may then be replaced to hold the retainers within the track. In normal usage there are as many retainers 12 as vanes 2. In an embodiment, the track 10 terminates against the side of the window frame, without the need for a block.

The retainer 12 has an upper portion 16 having a blind-retaining clip 6, and a lower portion 18 with a friction-reducer 20 such as wheels or a low-friction nylon slider (not shown), the upper and lower portions 16, 18 connected by a rod 22. The friction-reducer 20 is adapted to fit within the groove 14 and, once therein, remain within the groove as it is too wide to be removed through the opening of the groove 14. In an embodiment, the friction-reducer 20 comprises a set of wheels 24 rotatably mounted on either side of the lower part of the rod, wherein the width of the friction-reducer 20 is greater than the width of the groove 14. The blind-retaining clips 6 are installed by sliding them onto the bottoms of vanes 2, yet tightly and securely grip vanes 2 once installed, by means of a friction fit or positive engagement with the vane through a protrusion on the clip 6 passing through an aperture in the vane 2 (not shown).

In an embodiment of the invention, the track may be installed below a sliding glass door, for access to a patio or yard, for example. In order to avoid causing a tripping hazard, the track sides 25 are inclined to form a smooth transition from the floor, such that a person's foot is less likely to catch. Additionally, the sides may be reinforced so that they do not collapse or break by being struck by a person's foot.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed.

I claim:

1. An apparatus for preventing vertical blind vanes from swaying, comprising:
a. a cord;
b. a plurality of clips having an upper portion; and
c. one or more annular eyelet holes in communication with the plurality of clips, wherein the plurality of clips slidingly engage a bottom edge of the vanes, and wherein the cord extends through the one or more eyelet holes.

2. The apparatus of claim 1, further comprising at least one anchor coupled to each end of the cord, the at least one anchor being capable of attaching to a sides of a window frame to secure the cord in a tensioned position below the vanes.

3. The apparatus of claim 1, further comprising brackets coupled to each end of the cord, the brackets being capable of attaching to the wall on each the of a window and securing the cord in a tensioned position below the vanes.

4. The apparatus of claim 1, wherein the clips are attached to the bottom edges of the vanes at the vanes' mid-point, and wherein the cord is tensioned such that the pendulum motion of the vanes is prevented.

5. A method for preventing vertical blind vanes from swaying, comprising:
a. providing a cord running through a eyelet holes, wherein the eyelet holes are attached to a plurality of clips having an upper portion, and wherein plurality of clips are capable of gripping the bottom of the vanes;
b. securing the cord below the vanes;
c. coupling each end of the cord to the sides of a window frame or the walls on each side of a window;
d. sliding the upper portion of the plurality of clips onto the bottom edges of the vanes at the vanes' mid-point, wherein bottom edges of the vanes slide into the upper portion of the plurality of clips; and
e. tightening the cord, wherein the cord is tensioned such that the pendulum motion of the vanes is prevented.

6. The apparatus of claim 1, wherein the vanes comprise curled lateral edges, wherein one lateral edge of each vane curls toward one surface of vane while the other lateral edge curls toward the opposite surface of vane, such that the lateral edges of adjacent vanes interlock when the vanes are in a closed position.

7. (canceled)

8. An apparatus for preventing vertical blinds from swaying, comprising:
a. a track having a t-shaped groove therein;
b. one or more retainers slidably disposed within the track, the retainer comprising:
i. a clip having an upper portion for removably retaining blinds, and a lower portion, wherein the upper portion is configured to slidingly engage a bottom edge of a vane;
ii. a friction-reducer configured to facilitate movement of the retainers within the track, wherein the friction-reducer is in communication with the lower portion, and wherein the lower portion is in communication with the upper portion,
wherein the friction reducer is in communication with an interior surface of the track.

9. The apparatus of claim 8, wherein the friction-reducer comprises wheels on either side of the retainer, wherein the wheels extend outward from the lower portion toward the interior surface of the track.

10. The apparatus of claim 8, wherein the track has ends that are open for insertion of the one or more retainers into the track.

11. (canceled)

12. The apparatus of claim 10, wherein the track is attached to a floor.

13. The apparatus of claim 8, wherein the blinds comprise a plurality of vanes having curled lateral edges, wherein one lateral edge of each of the plurality of vanes curls toward one surface of each of the plurality of vanes while the other lateral edge curls toward the opposite surface of each of the plurality of vanes, such that the lateral edges of adjacent vanes interlock when the vanes are in a closed position.
